(19) United States
(12) Patent Application Publication
(10) Pub. No.: US 2014/0256329 A1
(43) Pub. Date: Sep. 11, 2014

(54) HETEROGENEOUS CELLULAR NETWORK

(71) Applicant: HITACHI, LTD., Tokyo (JP)

(72) Inventors: Dongxu CAO, Beijing (CN); Chunguang LIU, Beijing (CN); Sheng ZHOU, Beijing (CN); Peng YANG, Beijing (CN); Zhisheng NIU, Beijing (CN); Mika MIZUTANI, Beijing (CN)

(73) Assignee: HITACHI, LTD., Tokyo (JP)

(21) Appl. No.: 14/197,753

(22) Filed: Mar. 5, 2014

(30) Foreign Application Priority Data
Mar. 11, 2013 (CN) 201310076449.1

(51) Int. Cl. H04W 36/20

(52) U.S. Cl. CPC H04W 36/20
USPC 455/444

(57) ABSTRACT

Provided is a micro base station to be used in a heterogeneous cellular network. The micro base station has resources including frequency bands and time slots and being available for a user to use. The heterogeneous cellular network includes a plurality of base stations including a macro base station and the micro base station. The micro base station includes: an information acquiring part configured to acquire configuration information and load information of the micro base station, and to acquire configuration information and load information of a neighboring base station adjacent to the micro base station from the neighboring base station; and a resource selection part configured to select a part of the resources from the resources to provide the selected part of the resources to the user based on the configuration information and the load information of the micro base station and the neighboring base station.

### CLAIM OF PRIORITY

The present application claims priority from Chinese patent application No. 201310076449.1 filed on Mar. 11, 2013, the content of which is hereby incorporated by reference into this application.

### BACKGROUND

This invention relates to a heterogeneous cellular network.

Currently, a conventional cellular network (hereinafter sometime referred to as homogeneous cellular network) including only one type of base station is widely used. A cellular network (hereinafter also referred to as “heterogeneous cellular network”) including many types of base stations has also been researched and developed, and is being gradually applied and popularized.

FIG. 9 is a block diagram illustrating a configuration of the heterogeneous cellular network. In the heterogeneous cellular network illustrated in FIG. 9, there are four macro base stations (Macro BS) MBS and eight micro base stations mBS. Here, the micro base station is a generic term for mini type base stations, which are different from the macro base station, including, for example, femto base stations (Femto BS), pico base stations (pico BS), micro base stations (Micro BS), and the like. Further, MC (also referred to as “macro cell”) represents a cell covered by the macro base station MBS, and mC (also referred to as “micro cell”) represents a cell covered by the micro base station mBS.

Usually, the transmitting power of the micro base station is much lower than that of the macro base station, the coverage area of the micro cell is much smaller than that of the macro cell, and a probability that the number of users of the micro cell is smaller than that of the macro cell is high. However, in the related art, same frequency bands may be allocated to the micro base station and the macro base station, or in order to reduce interference between cells, different frequency bands may also be allocated to the micro base station and the macro base station. In addition, the frequency bands to be allocated to the micro base station and the macro base station are often in either state of being used up completely or being completely off.

Thus, when the same frequency bands are allocated to the micro base station and the macro base station, the micro base station allocates all of the frequency bands to the users in the micro cell. As a result, there is a fear of providing the so-called excess service of more than a required number of frequency bands for the users. For that reason, there exist problems in that not only the resources are wasted due to providing the excess service, but also the interference between cells becomes stronger because the micro base station and the neighboring base station use the same frequency bands, resulting in reducing the network capacity.

In order to reduce the interference, US2012/0157108A1 discloses a technology of a fractional frequency reuse mechanism for a heterogeneous cellular network. The mechanism is a direct extension of the fractional frequency reuse mechanism in the traditional homogeneous cellular network, i.e., allocating resources based on the user's position information. Further, WO2012/106987A1 discloses a solution of reducing the interference, in which the base station and the micro node in a heterogeneous cellular network use different position information.

### SUMMARY

As described above, most of the homogeneous cellular networks use the full frequency reuse mechanism for 3G and future standards. However, the heterogeneous cellular network slightly differs from the homogeneous cellular network in that the heterogeneous cellular network includes different types of coverage capacities, and uses different types of base stations. As a result, the differences between the base stations and between the cells make the full frequency reuse mechanism be no longer the optimal reuse mechanism of the heterogeneous cellular network.

Thus, it is desired to reduce the same frequency interference between cells in a heterogeneous cellular network, thereby enhancing the network capacity.

An aspect of the invention is a micro base station to be used in a heterogeneous cellular network. The micro base station has resources including frequency bands and time slots and being available for a user to use. The heterogeneous cellular network includes a plurality of base stations including a macro base station and the micro base station. The micro base station includes: an information acquiring part configured to acquire configuration information and load information of the micro base station, and to acquire configuration information and load information of a neighboring base station adjacent to the micro base station from the neighboring base station; and a resource selection part configured to select a part of the resources from the resources to provide the selected part of the resources to the user based on the configuration information and the load information of the micro base station and the neighboring base station, which are acquired by the information acquiring part.

An aspect of the invention allows reduction of the same frequency interference between cells in a heterogeneous cellular network, thereby enhancing the network capacity.

### BRIEF DESCRIPTION OF THE DRAWINGS

FIG. 1A is a block diagram schematically illustrating a configuration of a micro base station in a heterogeneous cellular network of the embodiment.

FIGS. 1B to 1D are schematic diagrams illustrating selections of resources of the micro base station of the embodiment, which are available for users to use.

FIG. 2 is a block diagram schematically illustrating a configuration of a macro base station in the heterogeneous cellular network of the embodiment.

FIG. 3 is a flowchart illustrating a resource selection method for a micro base station in the heterogeneous cellular network of the embodiment.

FIG. 4 is a flowchart illustrating a resource allocation method for a macro base station in the heterogeneous cellular network of the embodiment.

FIG. 5 is a message signaling diagram during an exchange of configuration information between the base stations of the embodiment.

FIG. 6 is a message signaling diagram of the embodiment when the micro base station of this invention acquires load information from the macro base station.

FIG. 7 is a diagram illustrating a format of the message signaling of FIGS. 5 and 6.

FIG. 8 is a diagram illustrating a processing of the micro base station of the embodiment randomly selecting M resource blocks from N resource blocks to provide the selected M resource blocks to the users.

FIG. 9 is a block diagram illustrating a configuration of the heterogeneous cellular network.

### DETAILED DESCRIPTION OF EMBODIMENTS

Now, description is made of an embodiment of the invention. The embodiment descries a heterogeneous cellular network based on a fractional frequency reuse mechanism and a micro base station to be used therein and a resource selection method for the micro base station, which may reduce the same frequency interference between cells, thereby enhancing the network capacity.

The embodiment presents a distributed type fractional frequency reuse mechanism, and the reuse mechanism may adjust self-adaptively with change of a network load. In particular, the fractional frequency reuse mechanism may be applied for the cases where the loads of respective cells are unbalanced (e.g., hot spot area) and the user requirements of the respective cells are different, and may also adjust self-adaptively to activation and hibernation of the base station.

The heterogeneous cellular network of the embodiment includes a plurality of base stations including two types of base stations including a macro base station and the micro base station, and the macro base station and the micro base station each have resources available for users to use. The “resources” referred herein include frequency bands and time slots.

The macro base station includes an information acquiring part configured to acquire configuration information and load information of the macro base station itself, and a resource allocation part configured to allocate the resources possessed by the macro base station itself to a user.

The micro base station includes an information acquiring part configured to acquire configuration information and load information of the micro base station itself, and to acquire configuration information and load information of a neighboring base station from the base station adjacent to the micro base station, and a resource selection part configured to select a part of the resources from the resources to provide the selected part of the resources to the user based on the configuration information and the load information of the micro base station itself and the neighboring base station, which are acquired by the information acquiring part.

The micro base station may select a part of the resources as little as possible from all of the resources including frequency bands and time slots to provide the selected part of the resources to the user. Thus, the idle resources may be increased and the same frequency interference between cells may be reduced while ensuring the user requirements, thereby being capable of enhancing the network capacity. The “neighboring cell (or neighboring base station)” used herein refers to a neighboring cell (or neighboring base station) having its boundary connecting to or an area intersecting with the cell covered by the base station.

Further, the “configuration information” used herein means information on a configuration of a base station, including, for example, a position of a base station, transmitting power (Pm, PM), micro base station density (ρm), and macro base station density (ρM). Characters including m represent value of micro base stations and characters including M represent values of macro base stations.

In addition, the “load information” used herein refers to information on users within a cell covered by a base station, including, for example, rate requirement (um, uM) of a single user within the cell (hereinafter abbreviated as “user rate requirement”), user density (λm, λM) within the cell.

When the micro base station cannot acquire the load information of its own cell due to load measurement, or the like, a predetermined value can be used as its replacement. When the micro base station cannot acquire the load information of the neighboring cell due to information exchange, or the like, the load information of the neighboring cell can be estimated by utilizing the information measured by the micro base station itself, and can be assumed that uM=um, λM=λm.

Embodiments of the invention are described below with reference to the drawings, but these embodiments are only examples for illustrating specific operations of the above-mentioned embodiments of the invention, and are not intended to limit the scope of claim of the invention. Therefore, according to a gist of the embodiments, new technical solution may be formed through addition or deletion of the component thereof.

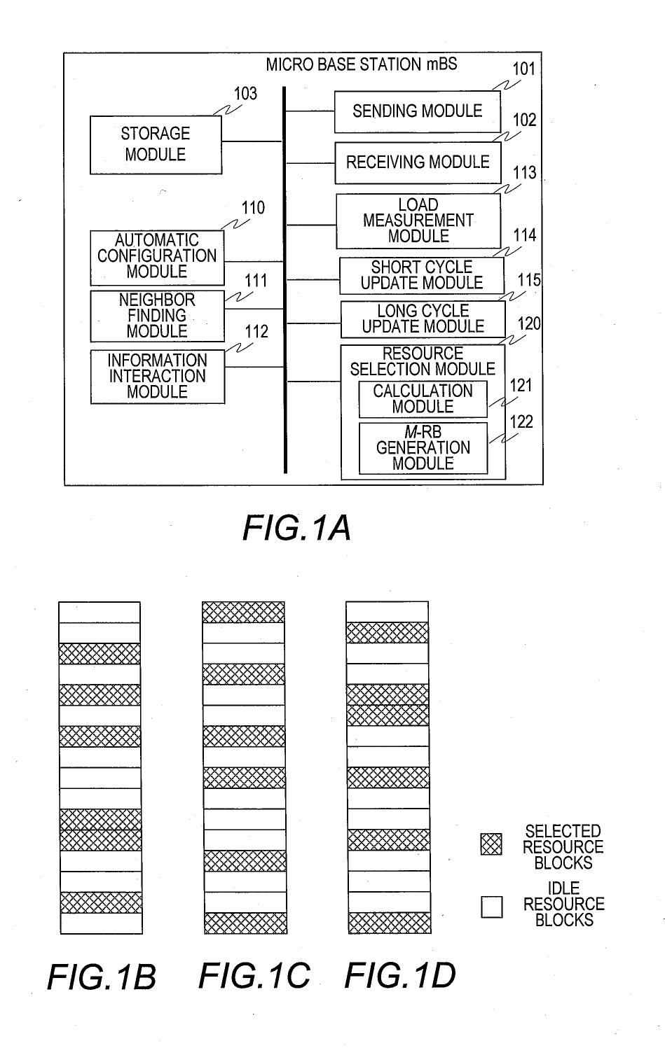

A configuration of the micro base station of the embodiment is illustrated below with reference to FIGS. 1A to 1D.

FIG. 1A is a block diagram schematically illustrating a configuration of a micro base station in a heterogeneous cellular network of the embodiment, and FIGS. 1B to 1D are schematic diagrams illustrating selections of resources of the micro base station of the embodiment, which are available for users to use.

As illustrated in FIG. 1A, the micro base station mBS in the heterogeneous cellular network includes a sending module 101, a receiving module 102, a storage module 103, an automatic configuration module 110, a neighbor finding module 111, an information exchange module 112, a load measurement module 113, a short cycle update module 114, a long cycle update module 115, and a resource selection module 120. Of those, the resource selection module 120 includes a calculation module 121 and an M-RB (M random resource blocks) generation module 122. These modules may be configured by a processor operable according to programs and/or dedicated hardware circuits.

The sending module 101 is used to send message signals, and the like including data and information, to outside users, other base stations, and the like within the heterogeneous cellular network.

The receiving module 102 is used to receive message signals, and the like including data and information, sent from outside users and other base stations, and the like within the heterogeneous cellular network.

The storage module 103 is used to store various data, information, and the like.

The automatic configuration module 110 is used to acquire configuration information such as ID, position, and transmitting power Pm of the micro base station itself, and further acquire configuration information such as macro base station density ρM and micro base station density ρm from a heterogeneous cellular network.

The neighbor finding module 111 is used to find neighboring base stations including a neighboring micro base station(s) and a neighboring macro base station(s). For example, from a user roamed from a neighboring cell, the information of the base station to which the neighboring cell belongs, for example, ID of the base station, is acquired.

The information exchange module 112 is used to exchange various kinds of information, for example configuration information and load information, with a neighboring base station. Of course, when the other base station does not need (does not require) those information, there is no need to send those information, and is only required to receive and acquire those information.

The load measurement module 113 is used to estimate a size of the micro cell covered by the micro base station, and to measure an actual load of the micro cell, to thereby acquire the load information of the micro base station. For example, the user density λm within the micro cell and the user rate requirement um of the micro cell are calculated.

The short cycle update module 114 is used to newly select the resources to be provided for users to use within a relatively short cycle by the M-RB generation module 122, and in this case, it is not required to update the system parameter. In this case, a length of the short cycle is not particularly limited, and the length may be set as needed. Moreover, an operation of the short cycle update can be triggered by a given time or a given event.

The long cycle update module 115 is used to newly select the resources provided for users to use within a relatively long cycle by the calculation module 121 and the M-RB generation module 122, and in this case, it is required to update the system parameter. In this case, a length of the long cycle is also not particularly limited, the length may only be set to be longer than that of the short cycle. Moreover, an operation of the long cycle update can be triggered by a given time or a given event.

The resource selection module 120 is used to select a part of the resources (M, N≧M) to provide the selected part of the resources to the users from all resources (e.g., N) that are available for users to use, according to the acquired configuration information and the load information of the micro base station itself and a neighboring base station. M represents the selected amount of resources. In this selection, the optimal resources may be precisely selected. In this case, however, the interference may be further reduced, but the process is very complicated and time consuming. Accordingly, the selection is carried out at random so that the process may be made simple.

Now, while describing the calculation module 121 and the M-RB generation module 122, a specific processing for resource selection is described, but it is not limited thereto, it suffices that as much idle resources as possible can be remained while the user requirements are ensured.

The calculation module 121 is used to perform calculations. For example, the values of β and M are calculated according to Equations (1) to (3).

$$\begin{matrix}c = {( \frac{{P}_{M}}{{P}_{m}} )}^{2 / α} & Equation ( 1 ) \\ β = min \{ \frac{{u}_{m}}{{u}_{M}} \frac{c {ρ}_{M} + {ρ}_{M} + {λ}_{m}}{c {ρ}_{M} + {ρ}_{m} + c \overline{{λ}_{M}}} , 1 \} & Equation ( 2 ) \\ M = ⌈ N β ⌉ & Equation ( 3 )\end{matrix}$$

where:

c represents a system parameter, and is determined depending on transmitting powers of the macro base station and the micro base station;

Pm represents a transmitting power of the micro base station;

PM represents a transmitting power of the macro base station;

α represents a path loss factor, which is usually a constant, typically 3.7, 4, etc.;

um represents a user rate requirement of a single user within the micro cell;

uM represents a user rate requirement of a single user within the macro cell;

ρm represents a micro base station density, indicating a number of active micro base stations per unit area, excluding the dormant micro base stations, etc.;

ρM represents a macro base station density, indicating a number of active macro base stations per unit area, excluding the dormant macro base stations, etc.;

λm represents a user density within a micro cell, indicating a number of the users having service requests per unit area, excluding standby or dormant users;

λM represents a user density within a macro cell, indicating a number of the users having service requests per unit area, excluding standby or dormant users;

λ̅M̅ represents an average value of the user densities of a plurality of macro cells;

N represents a total number of the resource blocks in which the resources available for users to use is divided;

M represents a number of a part of the resource blocks selected from N resource blocks to be provided for the users to use.

When Equation (2) is expressed by β=min{A, B}, it means that β equals to the smaller number among A and B. When β, which is calculated by Equation (2), equals to 1, it means that the micro base station is required to select all the resource blocks to provide the selected part of the resources to the user, and when β is less than 1, the smaller the value of β is, the less resource blocks are selected, and the more idle resource blocks there are.

M and N are both integers, Nβ is rounded up when Nβ is not an integer. For example, if Nβ=2. 3, then M=3. Because β is less than or equal to 1, M is also less than or equal to N.

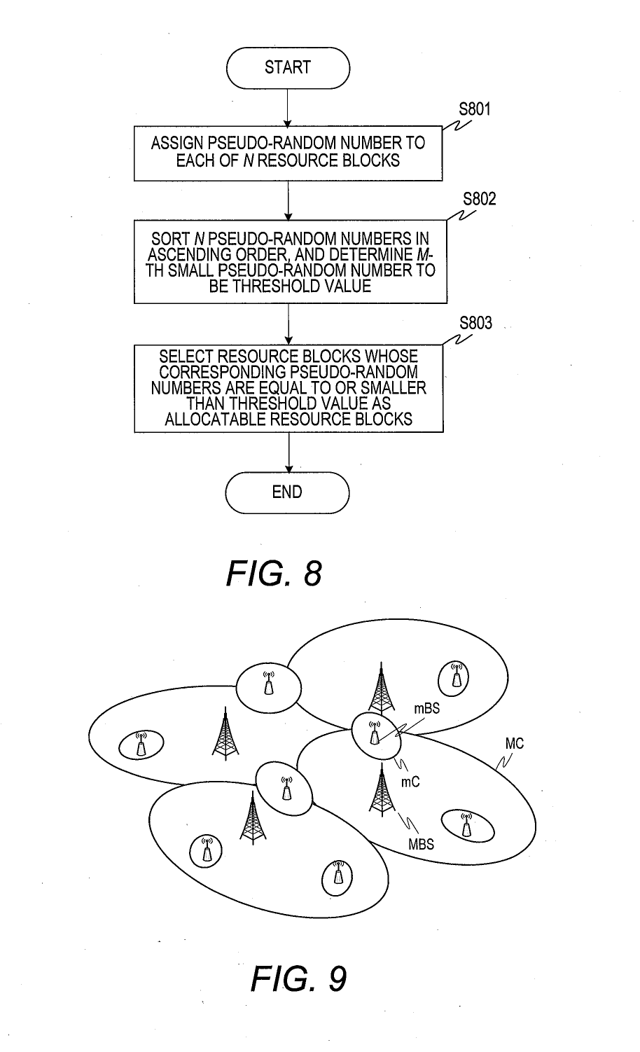

The M-RB generation module 122 randomly selects M resource blocks from N resource blocks to provide the selected M resource blocks to the users. In the description below, the process will be described in details with reference to FIG. 8.

In the above-mentioned description, description is made of an example of calculating the values of β and M by Equation (1) to (3), and then selecting M resource blocks from N resource blocks to provide the selected M resource blocks to the users. However, the embodiment is not limited thereto, it suffices that the number of the selected resources can be reduced as much as possible while the user requirements are ensured.

For example, it is needless to say that the calculating equations (Equation (1) and Equation (2)) of β can use the other load information and configuration information. Further, the number of blocks (M) of the selected resource blocks does not necessarily need to directly use the M value calculated by Equation (3), but can be obtained according to the M value. For example, there can be obtained by multiplying M by a factor greater than one, or by adding a given value (e.g., 1, 2) to M. In this case, it results in selecting more resources. However, a certain room may be provided for the user requirements, thereby being capable of satisfying more the user requirements.

FIGS. 1B to 1D each illustrate the selection solutions of the resources available for users to use, and in this case, N=16 and M=6. Specifically, the micro base station can provide a total of 16 resource blocks for the users, within which 6 resource blocks are selected to provide for the users to use. Accordingly, the number of the idle resource blocks becomes 16−6=10, and hence the frequency interference between cells can be greatly reduced to enhance the network capacity.

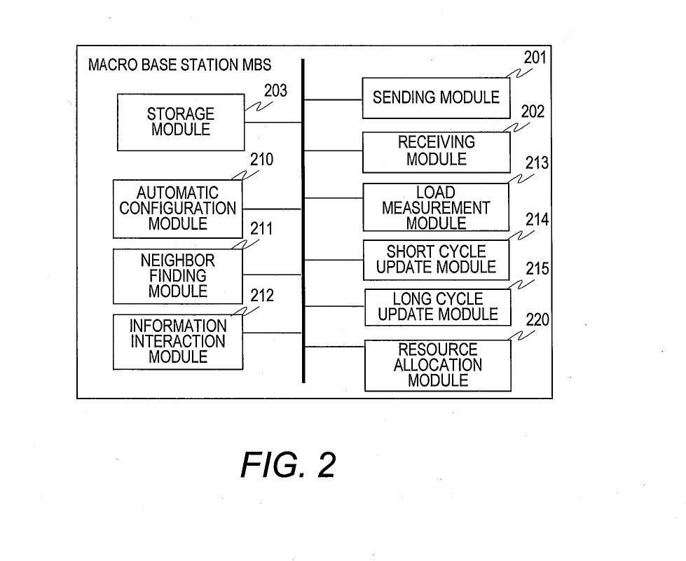

Next, the configuration of the macro base station of the embodiment is illustrated with reference to FIG. 2.

FIG. 2 is a block diagram schematically illustrating a configuration of a macro base station in the heterogeneous cellular network of t the embodiment.

As illustrated in FIG. 2, the macro base station MBS in the heterogeneous cellular network includes a sending module 201, a receiving module 202; a storage module 203, an automatic configuration module 210, a neighbor finding module 211, an information exchange module 212, a load measurement module 213, a short cycle update module 214, a long cycle update module 215 and a resource allocation module 220. These modules may be configured by a processor operable according to programs and/or dedicated hardware circuits.

The sending module 201 is used to send message signals, and the like including data and information to outside users and other base stations of the heterogeneous cellular network, and the like.

The receiving module 202 is used to receive message signals, and the like including data and information sent from outside users and the other base stations of the heterogeneous cellular network, and the like.

The storage module 203 is used to store various data, information, and the like.

The automatic configuration module 210 is used to acquire the configuration information such as ID, position, and transmitting power PM of the macro base station itself, and further acquire the configuration information such as macro base station density ρM, micro base station density ρm, and the like from a heterogeneous cellular network.

The neighbor finding module 211 is used to find neighboring base stations including a neighboring micro base station(s) and a neighboring macro base station(s). For example, from a user roamed from a neighboring cell, the information of the base station to which the neighboring cell belongs, such as ID of the base station, is acquired.

The information exchange module 212 is used to exchange various kinds of information, for example configuration information and load information, with a neighboring base station. Of course, when the macro base station does not need the information, there is no need to request the neighboring base station to send those information, and is required to only send those information.

The load measurement module 213 is used to estimate a size of the macro cell covered by the macro base station, and to measure an actual load of the macro cell, to thereby acquire the load information of the macro base station. For example, the user density λM within the macro cell and the user rate requirement uM of the macro cell are calculated.

The short cycle update module 214 is used to newly allocate the resources for users to use within a relatively short cycle by the resource allocation module 220. In this case, a length of the short cycle is not particularly limited.

The long cycle update module 215 is used to newly select the resources provided for users to use within a relatively long cycle by the resource allocation module 220, and in this case, it is required to update the system parameter. In this case, a length of the long cycle is also not particularly limited as in the case of the short cycle.

The resource allocation module 220 is used to allocate resources to the users for use.

As described above, the micro base station differs from the macro base station in regard to the allocations of resources to users. The macro base station directly allocates all resources to users for use. However, the micro base station first selects a part of the resources from all resources, and then allocates the selected part of the resources to users for use. Thus, the other part of resources becomes an idle state, thereby being capable of reducing the interference between cells to enhance the network capacity.

Further, the processing of the micro base station configured to select a part of the resources from all the resources can be randomly repeated within a given cycle, thus the selected resource blocks and the number of the selected resource blocks will also change. Accordingly, when the resources such as frequency bands with very strong interference, and the like, exist, there is no case where the frequency bands with very strong interference are continuously used.

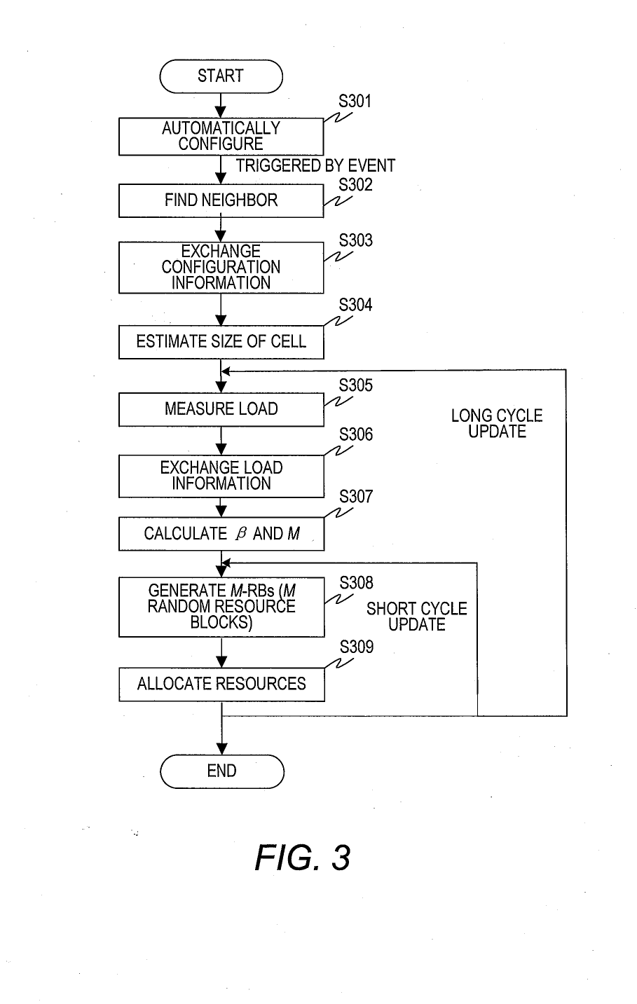

Now, description is made of the resource allocation method for a micro base station of the embodiment with reference to FIG. 3.

FIG. 3 is a flowchart illustrating a resource selection method for a micro base station in the heterogeneous cellular network of the embodiment.

As illustrated in FIG. 3, first, the micro base station carries out the automatic configuration processing, acquires the configuration information such as ID, position, and transmitting power of the micro base station itself, and further acquires the micro base station density ρm and the macro base station density ρM from the heterogeneous cellular network (Step S301).

After that, from a related user roamed from a peripheral cell to a current cell covered by the micro base station itself, ID of the base station, to which the peripheral cell belongs, is acquired, thereby finding the neighboring base station (also referred to as adjacent base station) (Step S302). Needless to say; the neighboring base station may be a macro base station, or may also be a micro base station, but for convenience of the description, it is assumed herein that the micro base station is only adjacent to other macro base stations.

Next, the configuration information such as position of a base station and transmitting power is interchanged with the found base station (Step S303).

After that, based on the strongest signal access standard, an area of the current cell is estimated (Step S304).

After that, the traffic load of the current cell is measured. For example, the numbers of the users having service requests at different points of time within a given period of time are sampled, and a mean value thereof is calculated. Further, based on the area estimated in Step S304, the user density λm within the micro cell is calculated. In addition, the user rate requirement um of the micro cell may be acquired from the service types of the user requests (Step S305).

Next, the load information is exchanged with the peripheral macro base station again, to thereby acquire the load information such as the user rate requirement uM, and the user density λM of the found neighboring macro base station (Step S306). In this case, when the neighboring macro base station does not require the load information, the load information of the micro base station itself may not be sent to the neighboring macro base station.

After that, the value of β is calculated according to the above-mentioned Equation (1) and Equation (2), and the value of M is calculated according to the above-mentioned Equation (3) (Step S307).

After that, M resource blocks are randomly selected from all of the N resource blocks to be provided for users to use (Step S308). In the following description, the random selection method for M resource blocks is described in detail with reference to FIG. 8.

After that, the M random resource blocks generated are allocated to users for use (Step S309). In this case, the related art may be used.

The update of the resource allocation includes a long cycle update and a short cycle update. When the long cycle update is carried out, it is necessary to newly calculate the values of β and M, and hence Step S305 to Step S309 are repeatedly carried out. When the short cycle update is carried out, the values of β and M are not newly calculated, and the value of M calculated before is directly used. By repeatedly carry out only Step S308 to Step S309, the frequency band selection becomes more rapid and more convenient.

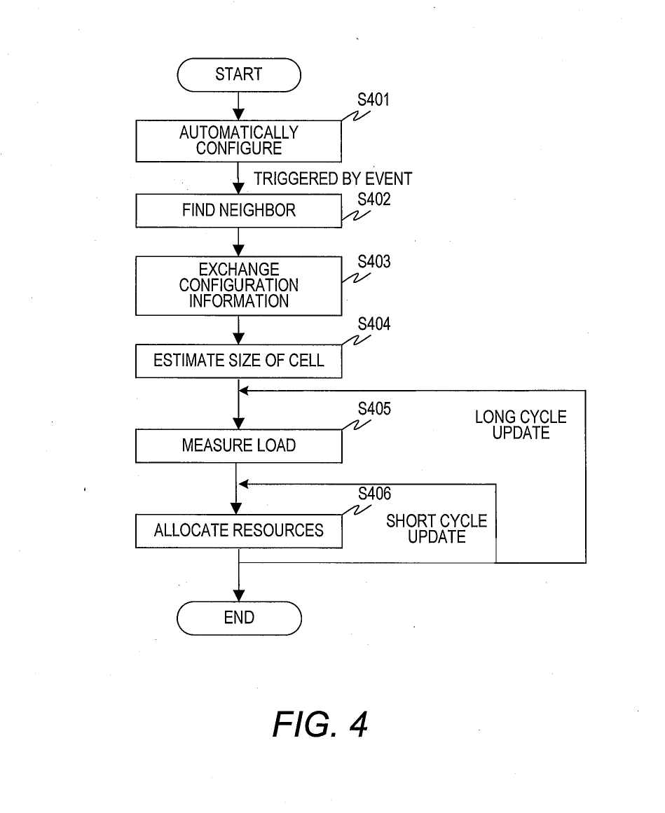

Now, description is made of a resource allocation method for a macro base station of the embodiment with reference to FIG. 4.

FIG. 4 is a flowchart illustrating a resource allocation method for a macro base station in the heterogeneous cellular network of the embodiment. In this case, for convenience of the description, it is assumed that the macro base station does not need to acquire the load information of the neighboring base station.

As illustrated in FIG. 4, first, the macro base station carries out the automatic configuration processing to acquire the configuration information such as ID, position, and transmitting power of the macro base station itself and the micro base station density ρm and the macro base station density ρM from the network (Step S401).

After that, from a related user roamed from a peripheral cell to the current cell covered by the macro base station itself, ID of the base station to which the peripheral cell belongs is acquired, thereby finding the neighboring base station. The neighboring base station may be a macro base station, or may also be a micro base station (Step S402).

Next, the configuration information such as position of base station, and transmitting power is interchanged with the found base station (Step S403).

After that, based on the strongest signal access standard, an area of the current cell is estimated (Step S404).

After that, the traffic load of the current cell is measured. For example, the numbers of the users having service requests at different points of time during a given period of time are sampled, and a mean value thereof is calculated. Further, based on the area estimated in Step S404, the user density λM within the macro cell is calculated. In addition, the user rate requirement uM of the macro cell may be acquired from the service types of the user requests (Step S405).

Next, from all resources, resources provided for the users to use are allocated to the users (Step S406). In this case, the related art may be used.

The update of the resource allocation includes a long cycle update and a short cycle update. When the long cycle update is carried out, Step S405 to Step S406 are repeatedly carried out. When the short cycle update is carried out, only Step S406 is repeatedly carried out.

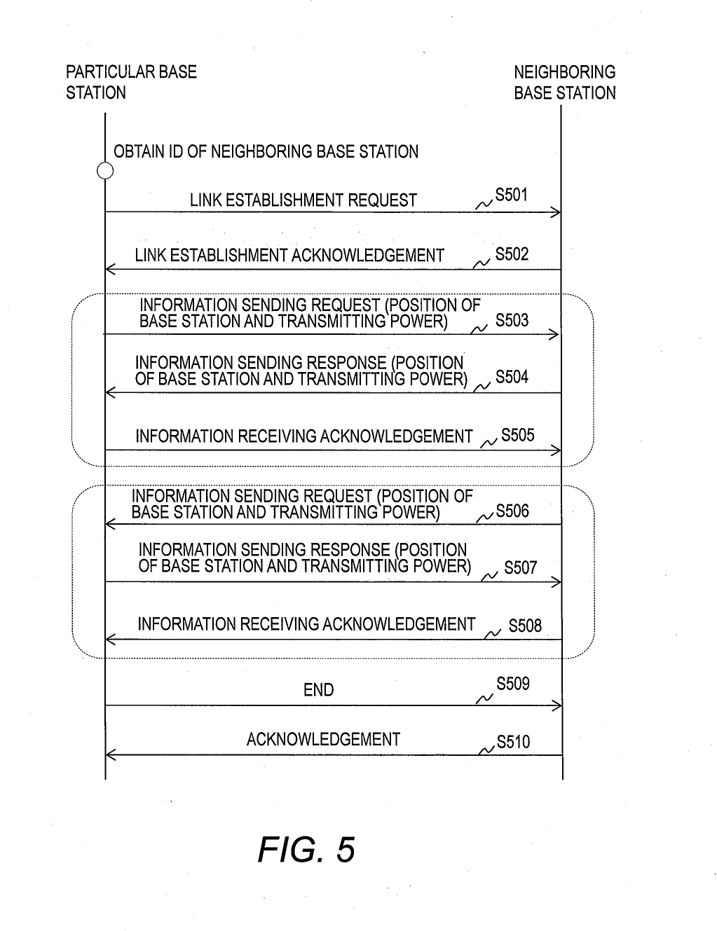

Now, descriptions are made of the specific processes of Step S303 of FIG. 3 and Step S403 of FIG. 4 of the embodiment with reference to FIG. 5.

FIG. 5 is a message signaling diagram during an exchange of configuration information between the base stations of the embodiment. Of those, the particular base station and the neighboring base station may be macro base stations, or may also be micro base stations. The format of the message signaling concerning various requests, responses, acknowledgements, and the like is described later in detail with reference to FIG. 7.

First, after the particular base station acquires ID of the neighboring base station (refer to Step S302, Step S402), the particular base station sends a link establishment request including ID of the neighboring base station to the neighboring base station, and requests the neighboring base station to establish a link with the neighboring base station (Step S501). The neighboring base station responds to the request, and sends an ACK (acknowledgement) message to the particular base station (Step S502). With this, a link between the particular base station and the neighboring base station is established.

After that, the particular base station sends a configuration information sending request, to the neighboring base station, for requesting the configuration information such as position of the base station, and transmitting power of the neighboring base station (Step S503). The neighboring base station responds to the request, and sends the configuration information such as position of the base station, and transmitting power of itself to the particular base station (Step S504). After receiving the configuration information, the particular base station sends an information receiving acknowledgement, to the neighboring base station, for acknowledging the receipt of the configuration information (Step S505).

Next, the neighboring base station sends a configuration information sending request, to the particular base station, for requesting the configuration information such as position of the base station, and transmitting power of the particular base station (Step S506). The particular base station responds to the request, and sends the configuration information such as position of the base station, and transmitting power of itself to the neighboring base station (Step S507). After receiving the configuration information, the neighboring base station sends an information receiving acknowledgement, to the particular base station, for acknowledging the receipt of the configuration information (Step S508).

After that, the particular base station sends a message to the neighboring base station indicating that the information exchange is completed (Step S509). The neighboring base station sends an ACK (acknowledgement) message to the particular base station (Step S510).

As described above, after passing through Step S501 to Step S510, the configuration information exchange (refer to Step S303, Step S403) between the particular base station and the neighboring base station is completed.

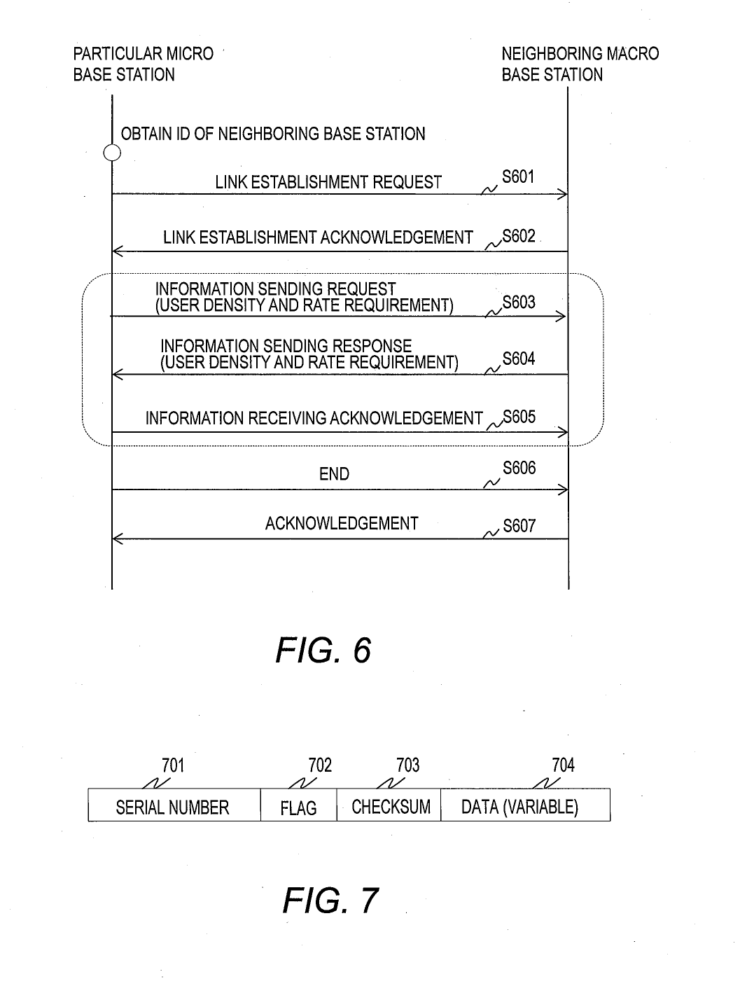

Now, description is made of the specific process of Step S306 of FIG. 3 of the embodiment with reference to FIG. 6.

FIG. 6 is a message signaling diagram when the micro base station of the embodiment acquires load information from the macro base station. The format of the message signaling concerning various requests, responses, and acknowledgements is described later in detail with reference to FIG. 7.

First, after the particular micro base station acquires ID of the neighboring macro base station (refer to Step S302), the particular micro base station sends a link establishment request including ID of the neighboring macro base station, to the neighboring macro base station, for requesting establishment of a link with the neighboring macro base station (Step S601). The neighboring macro base station responds to the request, and sends an ACK (acknowledgement) message to the particular micro base station (Step S602). With this, a link between the particular micro base station and the neighboring macro base station is established.

After that, the particular micro base station sends a load information sending request, to the neighboring macro base station, for requesting the load information such as user density and user rate requirement of the neighboring macro base station (Step S603). The neighboring macro base station responds to the request, and sends the load information such as user density and user rate requirement of itself to the particular, micro base station (Step S604). After receiving the load information, the particular micro base station sends an information receiving acknowledgement, to the neighboring macro base station, for acknowledging the receipt of the load information (Step S605).

Next, the particular micro base station sends a message to the neighboring macro base station indicating that the information exchange has been completed (Step S606). The neighboring macro base station sends an ACK (acknowledgement) message to the particular micro base station (Step S607).

Thus, after passing through Step S601 to Step S607, the particular micro base station acquires the load information of the neighboring macro base station.

Now, description is made of the format of various message signaling illustrated in FIGS. 5 and 6 with reference to FIG. 7.

FIG. 7 is a diagram illustrating a format of the message signaling of FIGS. 5 and 6.

As illustrated in FIG. 7, the messages such as the link establishment request, the link establishment acknowledgement, the information sending request, the information sending response, and the information receiving acknowledgement include those four domains of sequence number 701, flag 702, checksum 703, and data 704.

Of those, the serial number 701 is used to designate a serial number to the message.

The flag 702 indicates that the message type is any one of “request”, “response”, “acknowledgement (ACK)”, and “end (END)”.

The checksum 703 is used to indicate whether a verifying head has already been damaged.

The data 704 is used to record the content of the message and the length thereof is variable. When the flag 702 is a “request”, the data 704 contains a specific content of the request. When the flag 702 is a “response”, the data 704 contains a serial number of the response to the request and the content of the response. When the flag 702 is an “acknowledgement”, the data 704 contains the serial number of the acknowledgement. When the flag 702 is an “end”, the data 704 is blank.

Now, description is made of the specific process of Step S308 of FIG. 3 of the embodiment with reference to FIG. 8.

FIG. 8 is a diagram illustrating a processing of the micro base station of the embodiment randomly selecting M resource blocks from N resource blocks to provide the selected M resource blocks to the users. In the equation, N and M are positive integers and satisfy

As illustrated in FIG. 8, first, a pseudo-random number of from 1 to N is assigned to each resource block of N resource blocks (Step S801). Next, the N pseudo-random numbers acquired in Step S801 are sorted in an ascending order, and the Mₜₕ small pseudo-random number is determined to be a threshold value (Step S802). Finally, traversing the pseudo-random numbers corresponding to the N resource blocks, and comparing to the threshold value determined in Step S802, M resource blocks having a comparison result of “less than or equal to the threshold value” are selected from the N resource blocks (Step S803).

The invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

What is claimed is:

1. A micro base station to be used in a heterogeneous cellular network,
the micro base station having resources including frequency bands and time slots and being available for a user to use,
the heterogeneous cellular network comprising a plurality of base stations including a macro base station and the micro base station,
the micro base station comprising:
an information acquiring part configured to acquire configuration information and load information of the micro base station, and to acquire configuration information and load information of a neighboring base station adjacent to the micro base station from the neighboring base station; and
a resource selection part configured to select a part of the resources from the resources to provide the selected part of the resources to the user based on the configuration information and the load information of the micro base station and the neighboring base station, which are acquired by the information acquiring part.

2. The micro base station to be used in a heterogeneous cellular network according to claim 1, wherein:
the configuration information includes positions of the base stations and transmitting power;
the load information includes user rate requirement and user density;
the information acquiring part further acquires micro base station density and macro base station as configuration information density from the heterogeneous cellular network;
the resource selection part selects the part of the resources from the resources to provide the selected part of the resources to the user, based on the configuration information and the load information of the micro base station and the neighboring base station, and the micro base station density and the macro base station density, which are acquired by the information acquiring part.

3. The micro base station to be used in a heterogeneous cellular network according to claim 1, wherein the resource selection part determines an amount of the selected part of the resources and randomly selects the amount of resources from the resources to provide the part of the resources to the user.

4. The micro base station to be used in a heterogeneous cellular network according to claim 1, wherein:
all of the resources possessed by the micro base station are divided into N resource blocks, and that M resource blocks is selected from the N resource blocks as the part of the resources to be provided to the user, where N and M are positive integers and satisfy N≧M;
the resource selection part calculates a system parameter c based on the transmitting powers of the macro base station and the micro base station, and calculates a value of the M in accordance with the following equations,
$$β = min \{ \frac{{u}_{m}}{{u}_{M}} \frac{c {ρ}_{M} + {ρ}_{m} + {λ}_{m}}{c {ρ}_{M} + {ρ}_{m} + c \overline{{λ}_{M}}} , 1 \}$$
$$M = ⌈ N β ⌉$$
where um represents the user rate requirement of the micro base station, uM represents the user rate requirement of the macro base station, ρm represents the micro base station density, ρM represents the macro base station density, λm represents the user density of the micro base station, and λM represents the user density of the macro base station.

5. A resource selection method for a micro base station to be used in a heterogeneous cellular network,
the micro base station having resources including frequency bands and time slots and being available for a user to use,
the heterogeneous cellular network comprising a plurality of base stations including a macro base station and the micro base station,
the resource selection method comprising:
an information acquiring step of acquiring configuration information and load information of the micro base station, and of acquiring configuration information and load information of a neighboring base station adjacent to the micro base station from the neighboring base station; and
a resource selection step of selecting the part of the resources from the resources to provide the selected part of the resources to a user, based on the configuration information and the load information of the micro base station and the neighboring base station, and the micro base station density and the macro base station density, which are acquired by the information acquiring step.

6. The resource selection method for a micro base station to be used in a heterogeneous cellular network according to claim 5, wherein,
the configuration information includes positions of the base stations and transmitting power;
the load information includes user rate requirement and user density;
the information acquiring step further comprises acquiring micro base station density and macro base station density as configuration information from the heterogeneous cellular network;
the resource selection step comprises selecting the part of the resources from the resources to provide the selected part of the resources to a user, based on the configuration information and the load information of the micro base station and the neighboring base station, and the micro base station density and the macro base station density, which are acquired by the information acquiring step.

7. The resource selection method for a micro base station to be used in a heterogeneous cellular network according to claim 5, wherein the resource selection step determines an amount of the selected part of the resources and randomly selects the amount of resources from the resources to provide the part of the resources to the user.

8. The resource selection method for a micro base station to be used in a heterogeneous cellular network according to claim 5, wherein,
all of the resources possessed by the micro base station are divided into N resource blocks, and that M resource blocks is selected from the N resource blocks as the part of the resources to be provided to the user, where N and M are positive integers and satisfy N≧M;
the resource selection step calculates a system parameter c based on the transmitting powers of the macro base station and the micro base station, and calculates a value of the M in accordance with the following equations,
$$β = min \{ \frac{{u}_{m}}{{u}_{M}} \frac{c {ρ}_{M} + {ρ}_{m} + {λ}_{m}}{c {ρ}_{M} + {ρ}_{m} + c \overline{{λ}_{M}}} , 1 \}$$
$$M = ⌈ N β ⌉$$
where um represents the user rate requirement of the micro base station, uM represents the user rate requirement of the macro base station, ρm represents the micro base station density, ρM represents the macro base station density, λm represents the user density of the micro base station, and λM represents the user density of the macro base station.

9. A heterogeneous cellular network, comprising a plurality of base stations including a macro base station and a micro base station,
the macro base station and the micro base station each having resources including frequency bands and time slots and being available for a user to use,
the macro base station comprising:
an information acquiring part configured to acquire configuration information and load information of the macro base station; and
a resource allocation part configured to allocate the resources possessed by the macro base station to a user,
the micro base station comprising:
an information acquiring part configured to acquire configuration information and load information of the micro base station, and to acquire configuration information and load information of a neighboring base station from the base station adjacent to the micro base station; and
a resource selection part configured to select a part of the resources from the resources to provide the selected part of the resources to the user based on the configuration information and the load information of the micro base station and the neighboring base station, which are acquired by the information acquiring part, and further configured to allocate the part of the selected resources to the user.

10. The heterogeneous cellular network according to claim 9, wherein,
the configuration information includes positions of the base stations and transmitting power;
the load information includes user rate requirement and user density;
the information acquiring part of the micro base station further acquires micro base station density and macro base station density as configuration information from the heterogeneous cellular network;
the resource selection part of the micro base station selects the part of the resources from the resources to provide the selected part of the resources to the user, based on the configuration information and the load information of the micro base station and the neighboring base station, and the micro base station density and the macro base station density, which are acquired by the information acquiring part.

11. The heterogeneous cellular network according to claim 9, wherein the resource selection part of the micro base station determines an amount of the selected part of the resources and randomly selects the amount of resources from the resources to provide the part of the resources to the user.

12. The heterogeneous cellular network according to claim 9, wherein,
all of the resources possessed by the micro base station are divided into N resource blocks, and that M resource blocks is selected from the N resource blocks as the part of the resources to be provided to the user, where N and M are positive integers and satisfy N≧M;
the resource selection part of the micro base station calculates a system parameter c based on the transmitting powers of the macro base station and the micro base station, and calculates a value of the M in accordance with the following equations,
$$β = min \{ \frac{{u}_{m}}{{u}_{M}} \frac{c {ρ}_{M} + {ρ}_{m} + {λ}_{m}}{c {ρ}_{M} + {ρ}_{m} + c \overline{{λ}_{M}}} , 1 \}$$
$$M = ⌈ N β ⌉$$
where um represents the user rate requirement of the micro base station, uM represents the user rate requirement of the macro base station, ρm represents the micro base station density, ρM represents the macro base station density, λm represents the user density of the micro base station, and λM represents the user density of the macro base station.
